(19) United States
(12) Patent Application Publication
(10) Pub. No.: US 2011/0131128 A1
(43) Pub. Date: Jun. 2, 2011

(54) METHOD AND MEANS FOR CONTROLLING PAYMENT SETUP

(76) Inventor: Mikko VÄÄNÄNEN, Helsinki (FI)

(21) Appl. No.: 12/883,232

(22) Filed: Sep. 16, 2010

(30) Foreign Application Priority Data
Dec. 1, 2009 (EP) 09177596

(51) Int. Cl. G06Q 40/00; G06Q 20/00; G06K 19/07; G06K 7/00; G06K 7/01

(52) U.S. Cl. 705/37; 235/380; 235/492; 235/435; 235/439; 705/39

(57) ABSTRACT

An electronic system with which consumers and businesses can automatically and electronically facilitate competition for financial transaction services that they purchase, and/or participate in bigger markets more transparently than they can currently. The system features a payment card, which is arranged to clear transactions with at least two accounts, which at least two accounts are arranged to be hosted by different financial service providers. The system also features a payment card reader, which is arranged to clear transactions with at least two accounts, which at least two accounts are arranged to be hosted by different financial service providers. The transaction computer server of the system is arranged to capture a competitive record of available bids that could have been accepted to complete the transaction from at least one the electronic market.

### TECHNICAL FIELD OF INVENTION

The invention relates to methods and devices for enhancing competition in the clearing of financial transactions for small parties. In particular, the invention relates to an electronic system with which consumers and businesses can automatically and electronically facilitate competition for financial transaction services that they purchase, and/or participate in bigger markets more transparently than they can currently.

### BACKGROUND

300 years after the birth of democracy in Western Europe, it is no longer the people and their democratically elected representatives that run independent nations and the economy. The banks run the economy. The average person in the western world is tied to his or her bank by such a multitude of ways, that the average person does not even understand half the mechanisms with which banks extract financial benefit from their customers. The transparency of the international financial markets to the average citizen or business is simply so poor, that it is impossible to know how much money have the financial services providers charged two parties when a transaction is cleared between them.

For example, assume that the average consumer, say for example from Finland visits London and buys a sandwich with his credit card. The purchased sandwich is charged in pounds, with a price of 4 pounds sterling for example. The consumer will receive the bill to his home when he returns to Finland. The consumer needs to pay a yearly subscription of typically 50 euros to the bank or the credit card company. On top of this fee, typically a 1.95% increase is added into the currency exchange rate charged from the consumer. The cafe that accepted the credit card will have to pay a yearly subscription for the card reader, and typically a 1-5% commission on all the transactions, depending on its creditworthiness and other factors. The aforementioned fees are collected by the banks, and typically not by the credit service company such as VISA, MASTERCARD or the like. The credit card company collects a multitude of fees from its member banks such as:
Card service fees: Determined by the number of credit cards issued and the extent to which they are used.
Data processing fees: Determined by each member's connections to the VisaNet or other processing systems and the extent to which these systems are used.
Multi-currency fees: Determined by the extent to which European credit cards are used outside the Europe region.
Interchange fees: Interchange is the fee paid between the issuing and acquiring banks every time a credit card is used. It has been designed to balance the cost of issuing and accepting credit cards.

Quite clearly there is a huge number of expense structures that are not available to the scrutiny of an individual or a business that uses the credit card to buy a product. Indeed, it could be said that it is impossible for a consumer to choose a service provider that is reliable (i.e. will not go bankrupt with your money and without clearing your deals) and cost efficient (i.e. does not charge too much for a simple service).

In the prior art, there are a number of technologies that increase consumer choice at the point of transaction, for example “Selectable multi-purpose card” U.S. Pat. No. 7,357,331 JPMorgan Chase Bank N.A., George Blossom, provides technologies on a single card with which a consumer can access a credit or a debit account, and see the balance. This prior art is cited as reference. The prior art technical solutions have significant drawbacks, however. When different accounts are from the same provider there is no competition.

U.S. Pat. No. 4,700,055 presents multiple credit card accounts in a single credit card to save wallet space. This document is also cited as reference.

WO03/010701 is a somewhat similar document as U.S. Pat. No. 4,700,055. WO03/010701 shows a multiple account payment card, which may be processed through a system that permits the card to access different accounts. This document is also cited as reference.

“EMV '96 Integrated circuit card specification for payment systems” EMV '96 specifications, 1996, shows multiple applications on a payment card.

US 2002/0087455 shows a global foreign exchange server system, where local level affiliates gather transactions to a global exchange or a hub to facilitate efficient currency transactions, especially when the transaction is coupled to the purchase of a real asset, such as a stock.

However, prior art suffers from a disadvantage. It is completely beside the point that the consumer, merchant, issuing bank or any other party could choose an account or payment service provider, if there is no way of him knowing what account or payment service provider should he choose to minimise unnecessary transaction costs. Furthermore, the prior art does not feature any solution to managing transaction setup when the fleet of payment cards is out in use with the public. Even further, the current systems of the prior art have no way of introducing competition between deal clearing service providers.

On the server side, the electronic prior art solutions report the conducted transaction meticulously. However, this reporting is opaque because it does not indicate the level of arbitrage extracted from the client at the point in time of the transaction, which arbitrage is typically a hidden, unreported cost in the actual price quote reported by the electronic trading server.

### SUMMARY

The invention under study is directed towards a system and a method for effectively bringing competitive market intelligence to individuals and businesses so that they can buy products more cheaply by making the financial transaction providers compete for their business. Further objective of the invention is to provide a system where the consumer, merchant, issuing bank and/or any other party can choose the most preferred account and/or payment service provider automatically.

A further object of the invention is to present a technical system and a method that allows a completely transparent, known transaction cost albeit unknown end cost, transaction to individuals and businesses in the currency markets, or in any other market.

One aspect of the invention involves a payment card that is arranged to control transaction setup from the credit card so that the transaction cost is minimised for the buyer, the buyer and the seller, the seller, or the card issuing bank or the bank of the merchant or both. The payment card in accordance with the invention is typically a credit card that is connected to two different accounts in two different banks in some embodiments. The credit card is typically a smart card, i.e. it has an IC chip on the card with a microprocessor, ROM/RAM/EEPROM memory and the like. In some embodiments the credit card also has a radio connection such as a RFID, or a cellular radio connection, plain radio connection or the like. In some embodiments the credit card may also feature a GPS (Global Positioning System) circuit or a like locating device. In some embodiments the credit card comprises a display.

Another aspect of the invention involves a single account associated with a single payment card in a single issuing bank, but multiple deal clearing service providers such as VISA, MASTERCARD, AMEX and the like. In this embodiment the payment card may list the different deal clearing service providers in an order of priority, and clear all transactions to the same account through the different deal clearing service providers in the order of preference. For example if VISA is the first preference on the payment card and MASTERCARD is the second preference, the payment card will always clear the transaction via the VISA network when that choice is available in the merchant terminal. If the merchant does not have a VISA network available in his card reader, but there is a MASTERCARD network available and some other networks such as AMEX, the payment card will execute the transaction via the MASTERCARD network, as that network is second in the order of preference. This way a payment card that is accepted broadly across merchant terminals of different types can be realised in accordance with the invention. Even further, in addition to having great interoperability characteristics the payment card saves money in transaction fees for the end customer and/or for the issuing bank whilst consolidating all the financial traffic to one single account that is easier for the end users to follow rather than multiple payment card- or financial network specific accounts.

In one aspect of the one account multiple deal clearing service providers embodiment mentioned in the preceding paragraph, the payment card simply offers the 1^{st} preference transaction network always, e.g. VISA, to the merchant terminal, and only moves to offering other subsequent networks if the merchant card terminal does not accept the first choice.

Payment card and credit card are used interchangeably in this application, and both cards are assumed to be applicable for direct payment, credit, and/or both. Credit card company, payment network, deal clearing service provider and/or payment service provider, payment service provider means are used interchangeably in this application to refer to the computer network that communicates electronic payment information and/or the party in control of the said computer network. A bank with its electronic computers may be a payment service provider also in some embodiments of the invention.

It is in accordance with the invention to assist the user in many ways to reduce the transactional cost that in itself does nothing to buy the product. In some embodiments the transaction cost plans provided by the banks are programmed into the memory of the credit card. Whichever bank has the cheapest transaction costs, gets to clear the transaction. As the transaction cost models of banks might change, it is in accordance with the invention that the transactional cost data on the credit card is sometimes updated from a network server via a radio path, or with a memory card reader, or other wireline system.

In one aspect of the invention in calculating which bank to choose the payment card may make use of the GPS or RFID data to deduce location, or it may capture that data from a card reader in the merchant terminal. Based on the location, or data from the merchant terminal, the credit card software may deduce the currency being used. By knowing the transaction costs associated with the banks, the currency exchange rates on offer in each transaction, and/or any other relevant data that might influence the short-term or long-term cost efficiency of the transaction, the control means on the credit card sets up the transaction with an account that offers the smallest transaction costs. In the one account multiple deal clearing service providers embodiment of the 4^{th} paragraph of this summary section, the preferred transaction service provider (such as VISA, MASTERCARD, AMEX) is chosen similarly as explained above to minimise transaction cost, maximise service reliability/quality and/or both. The order of preference could be composed based on the order of preference for the end customer and/or for the issuing bank.

The transactions can be multicurrency transactions or single currency transactions in accordance with the invention. In some embodiments of the invention, also more than two currencies may be used to conduct the transaction, for example by using another third currency as the medium of exchange, i.e. e.g. a euro-pound transaction can be split into euro-dollar-pound transaction in accordance with the invention.

In another embodiment of the invention, there is simply a screen on the credit card that shows the exchange rate of the currency being used to the base currency of the user. In this embodiment there may only be one account on the credit card, and the screen is used for informative purposes. In some embodiments the exchange rate is updated via the radio path as market conditions change. In some embodiments the screen shows the different exchange rates offered by the different banks, or the transaction costs offered by the different banks with which the credit card can execute a transaction. In some of these embodiments it is up to the consumer to then choose the bank he wants to execute the transaction with, based on more complete market information. In some embodiments the screen simply shows the best exchange rate, or the Interbank rate. In other embodiments it shows both the bank exchange rate and the Interbank rate, so the user can grasp how expensive the transactions truly are. In some embodiments both the exchange rate and the cost of the transaction for a particular financial service provider are shown on the display.

In many embodiments of the invention the combined cost of card service fees, data processing fees, multi-currency fees, interchange fees, subscription fees and/or currency spreads is minimised for the buyer, seller, or both, or the issuing bank, the bank of the merchant or both, or any combination of the aforementioned parties.

It is also in accordance with the invention that the merchant terminal may have multiple banks associated with it. In some embodiments the merchant terminal is arranged to choose which bank by the merchant is used to clear the transaction. In some embodiments the merchant terminal and the credit card exchange information when the card is read, and optimise the buyer bank-merchant bank pair, so that it bears the lowest aggregate transactional cost. Data with regard to the different cost models can be stored in the merchant terminal in accordance with the invention, and these may be updated to the merchant terminal by a wireline, wireless, radio, or card reader connection.

Similarly to the aforementioned in one aspect of the invention a card reading merchant terminal is associated with only one account, but multiple deal clearing service providers such as VISA, MASTERCARD, AMEX (American Express) or the like. In this aspect of the invention the merchant terminal reads the card and chooses deal clearing service providers such as VISA, MASTERCARD, AMEX in an order of preference that is stored on the merchant terminal Naturally this order of preference may be updated from a network server via a fixed connection and/or a radio path or other wireless connection.

In another embodiment of the invention there is a transaction computer server. In one embodiment of the invention this transaction computer server has access to the currency Interbank market or a like market. There is a further computing system storing electronic customer accounts, and the customers can access these accounts through the Internet or with a credit card in some embodiments. The transaction computer server and the accounts server are connected or they may even reside on the same server or server system. In addition, in some embodiments the transaction server system and/or the customer account system has accounts in different retail banks that the customers use. This way money may be routed to the customer account system from retail bank accounts via an intra-retail bank transfer, which in most EU jurisdictions is instantaneous. The money can now be transferred to an account in the same currency without bank charges, as intra-retail-bank charges should be free or controlled by the regulator.

When the customer decides to pay a fee to abroad, for example from the EU to the US, he will send money to the account in the same retail bank that the transaction server and/or the customer account system have access to. These funds can then immediately be accessed through the customer account system by the customer. The customer then accesses the customer account system and issues a bank transfer to the US account. During the process, or during the establishing of the account a ‘free market waiver’ is shown to the customer which authorises the party running the transaction server to perform the currency trade between EUR/USD, which is necessary to finalise the transaction. When in possession of the said free market waiver, the transaction server will automatically execute the trade in the currency market, preferably the Interbank market. In doing so, the transaction server will capture not only the exchange rate of the trade, but also the competitive landscape of the EUR/USD market at that time. In some embodiments this competitive landscape, i.e. the bidding record on the market is stored and attached to the transaction receipt of the customer. Then in some embodiments a flat commission charge is subtracted from the customer. Now, the customer can view the transaction completely transparently as the commission charge is shown in EUR or USD terms in the account statement. In addition and most importantly the customer now has no fear of arbitrage from the transactor. The customer can inspect the competitive record of different bids to verify that his transaction was indeed conducted at a rate that A) did exist on the market between two independent participants in competition B) Was reasonably placed in terms of the deal obtained within the market. The said bids in the competitive record are typically bids or transactions other than the transaction of the party himself.

Let us take a practical example that has happened in real life, situations like this occur in the EU every minute: A small business changes 200,000 euros to dollars. The bank statement will read: “exchange rate 1.2325, no commission or charges, end sum 246500 USD.” Did the bank do the trade really for free? If a local EU financial regulator is asked, the answer is yes.

A closer inspection will reveal that on that day when the trade occurred the Interbank market rate varied between 1.2350-1.2600. The exchange rate provided to the SME did not exist in the Interbank market. The bank claims that the transaction was conducted as a free market transaction from another bank, and no charges were levied. How can this be explained? The other bank that cleared the transaction as a counterparty turns out to be a subsidiary or a sister company of the earlier bank that did the deal for the customer. How much did the consolidated bank group charge?: first there is the 0.0025 difference between the reported exchange rate and the worst possible deal that the bank group could have made during the day when it needs to clear the transaction. The consolidated bank group charges 0.0025*200000=500 eur in the worst case. On top of that there is a variable 1.26−1.235=0.025 spread that the bank group can use to make more money during that day. For a normal average transaction where the bank group does not make a good or a bad guess but just places the trade on the market at random, the bank would finish on average in the middle of the spread range. In this event the bank makes 0.0125*200,000+500 eur=3000 eur in profit from the currency trade. If the trader beats the market, and trades at the best position, the bank group will make 5500 eur in fees, from a transaction that takes less than 5 seconds to do. It should be noted that the transaction has practically no risk, because the bank group will ultimately be of course exposed to both the currencies all the time.

The above explains why the average trader in a bank makes between 7-10 million euros for the bank every year irrespective of whether they perform well or whether they perform badly. A multimillion euro bonus every year is only a small fraction of the money these employees make, and because problems in the lending business are ultimately the taxpayers problem, there is little market pressure to use the trading income to subsidise other products such as consumer or business credit that pulls in the transaction business.

The SME that was charged 3000 eur for 5 seconds of work cannot legally claw back the charges because the regulator is investigating one legal person, i.e. one company at the time. The bank that made the deal with the SME got no charges, and the regulator concludes that the service was for free. The bank group gets the 3000 euros through the consolidated balance sheet. The SME was not the customer of the group, only its subsidiary, so the SME cannot sue the Group to claw back the fees for bank services that were charged at 2 million euros/hour.

The technical problem that faces the prior art is that of the ‘waterbed’ effect. I.e. the banks tie customers to themselves with different products such as the Internet bank terminal, loans etc, and necessitate the use of some services, such as currency exchange, that can be used to charge customers and businesses outrageous fees. It is technically impossible for the consumer or the business to access fair competitive markets from the bank terminal.

The invention solves this by bypassing the transactional infrastructure of the bank with an inventive transactional computer server system that can conduct transparent and verifiable currency transactions in the international wholesale money markets, interbank markets or other markets where independent financial players genuinely compete with each other. Consumers and businesses can now participate in the big markets, such as the Interbank market, through the inventive transactional bypass system whilst still remaining the customers of their respective banks for credit, deposit, mortgage and other products.

A payment card in accordance with the invention, is arranged to clear transactions with at least two accounts, is characterised in that data stored into the memory of the payment card and/or payment card reader is arranged to be used in determining an order of preference for the said accounts.

A payment card reader in accordance with the invention, is arranged to clear transactions with at least two accounts is characterised in that data stored into the memory of the payment card and/or payment card reader is arranged to be used in determining an order of preference for the said accounts.

A transaction computer server in accordance with the invention, comprising at least one memory storing at least one customer account and at least one communication connection with which at least one customer can access at least one account, and at least one communication connection to at least one electronic market where trading is arranged to take place is characterised in that,
at least one user is arranged to waive his or her requirements and accept a fair market price and/or rate,
the transaction server is arranged to capture a competitive record of available bids that could have been accepted to complete the said transaction from at least one said electronic market,
competitive record of available bids together with the conducted transaction is arranged to verify the transactional cost of executing the transaction.

A payment card arranged to access at least one transaction computer server of above.

A payment card reader arranged to access at least one transaction computer server of above.

A payment card comprising memory is in accordance with the invention and characterised in that,
the payment card is arranged to receive a data update from a network server,
the payment card is arranged to store said data into memory,
the said data update is arranged to be used in controlling financial transaction setup between the user of the card and merchants accepting the card.

A payment card reader comprising memory is in accordance with the invention and characterised in that,
the payment card reader is arranged to receive a data update from a network server,
the payment card reader is arranged to store said data into memory,
the said data update is arranged to be used in controlling financial transaction setup between a user of a payment card and the merchant accepting the card.

A payment card, comprising a memory chip is characterised in that, the memory chip is arranged to be inserted into a card reader in a mobile phone.

A payment card, arranged to clear transactions with at least one account, is characterised in that,
the said payment card is arranged to comprise data for accessing at least two deal clearing service providers,
the said payment card is arranged to comprise data indicating the order of preference of the said at least two deal clearing service providers.

A payment card reader, arranged to clear transactions with at least one account, is characterised in that,
the said payment card reader is arranged to comprise data for accessing at least two deal clearing service providers,
the said payment card is arranged to comprise data indicating the order of preference of the said at least two deal clearing service providers.

A payment card arranged to execute payments via at least two deal clearing service providers to and/or from one bank account only.

A payment card reader arranged to execute payments via at least two deal clearing service providers to and/or from one bank account only.

A method for payment set-up in a electronic payment system comprising a plurality of payment cards, at least one payment service provider means, at least one transaction server for storing service information received from at least one payment service provider means, and a electronic communication network via which payments are established in the system is in accordance with the invention and characterised in that,
at least one transaction server is in connection with at least one payment service provider means and stores the service information received via the connection,
all or part of the service information stored in the transaction server is transmitted to a control means in the payment card, and
the control means in the payment card stores the service information received from the transaction server, and the service information stored in the control means is used in controlling payment set-up from the payment card.

A method for payment set-up in a electronic payment system comprising a plurality of payment card readers, at least one payment service provider means, at least one transaction server for storing service information received from at least one payment service provider means, and a electronic communication network via which payments are established in the system is in accordance with the invention and characterised in that,
the transaction server is in connection with the payment service provider means and stores the service information received via the connection,
all or part of the service information stored in the transaction server is transmitted to the payment card reader, and
the payment card reader stores the service information received from the transaction server, and the service information stored in the card reader is used in controlling payment set-up from the payment card reader.

A electronic payment system comprising a plurality of payment cards, at least one payment service provider means, at least one transaction server, and a electronic payment network via which payments are arranged to be established in the system is in accordance with the invention and characterised in that the electronic payment system comprises at least one transaction server, the transaction server being arranged to be in connection with at least one payment service provider means,

a control means in the payment card is arranged to be in connection with the transaction server for the transmission of service information, the control means being arranged to control the payment set-up of the payment card on the basis of the service information.

A electronic payment system comprising a plurality of payment card readers, at least one payment service provider means, at least one transaction server, and a electronic payment network via which payments are arranged to be established in the system is in accordance with the invention and characterised in that the electronic payment system comprises at least one transaction server, the transaction server being arranged to be in connection with at least one payment service provider means,

at least one payment card reader is arranged to be in connection with the transaction server for the transmission of service information, the payment card reader being arranged to control the payment set-up of the payment card reader on the basis of the service information.

An electronic payment method between at least two accounts in at least two different currencies, used in a system comprising at least one memory storing at least one customer account and at least one communication connection with which at least one customer can access at least one account, and at least one communication connection to at least one electronic market where trading is arranged to take place is in accordance with the invention and characterised in that,
at least one user accepts a fair market price and/or exchange rate without prior knowledge of it,
a competitive record of at least one available bid that could have been accepted to complete the said transaction from at least one said electronic market is captured and stored,
the said competitive record verifies the transactional cost of executing the transaction.

By deal clearing service providers we mean financial transaction service companies that clear financial transactions between two or more parties through at least one communication network, such as VISA, MASTERCARD, AMEX, or the like in this application. These are of course commonly also known as credit card companies & payment networks that they operate in the usual vocabulary in some embodiments.

At this point in time the best mode of the invention is considered to be a multi-bank multi-account credit card that automatically chooses the most cost efficient transaction to clear the purchase. This is preferably used with a multi-bank multi account merchant terminal.

### BRIEF DESCRIPTION OF THE DRAWINGS

In the following the invention will be described in greater detail with reference to exemplary embodiments in accordance with the accompanying drawings, in which

FIG. 1 demonstrates an embodiment 10 of the inventive credit card that can use at least two financial services providers to clear the transaction in accordance with the invention.

FIG. 2 demonstrates an embodiment 20 of the inventive credit card-card reader combination in accordance with the invention.

FIG. 3 demonstrates an embodiment 30 of the method of use of the inventive credit card and/or card reader at the point of sale as a flow diagram in accordance with the invention.

FIG. 4 demonstrates an embodiment 40 of the inventive method for clearing a transaction as a flow diagram in accordance with the invention.

FIG. 5 demonstrates an embodiment 50 of the inventive software user interface as a block diagram in accordance with the invention.

FIG. 6 demonstrates an embodiment 60 of the inventive computer server arrangement as a block diagram in accordance with the invention.

FIG. 6B demonstrates an embodiment 61 of the inventive computer server arrangement for managing cross-currency electronic money transfers as a block diagram in accordance with the invention.

FIG. 7 demonstrates an embodiment 70 of the inventive computer server arrangement featuring at least one payment card and card reader as a block diagram in accordance with the invention.

FIG. 8 demonstrates an embodiment 80 of the inventive arrangement with which the issuing bank can control costs related to reciprocal transaction traffic.

FIG. 9 shows an embodiment 90 of the electronic payment setup control method and system in a block diagram, where control of payment setup is effected from the payment card.

FIG. 10 shows an embodiment 91 of the electronic payment setup control method and system in a block diagram, where control of payment setup is effected from the payment card reader.

Some of the embodiments are described in the dependent claims.

### DETAILED DESCRIPTION OF EMBODIMENTS

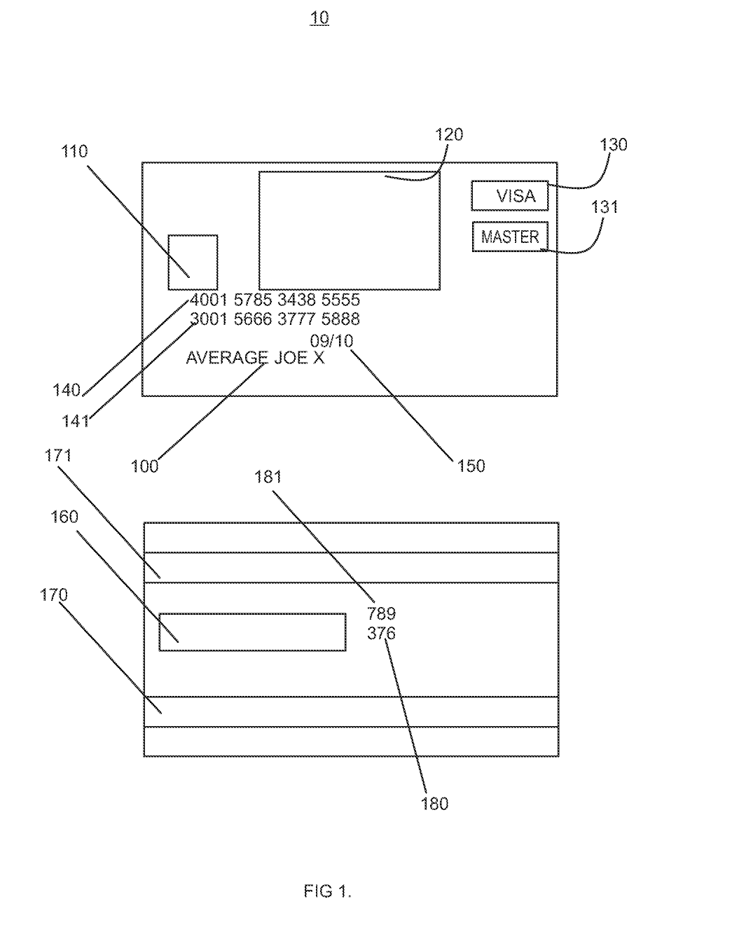

FIG. 1 shows the embodiment 10 of a payment card that can clear transactions through different financial service providers. In some embodiments it is only a payment card, in other embodiments it is a credit card, in some embodiments it is both. In some embodiments the payment card has two card numbers 140, 141. It typically has only one proprietor 100. Typically there is also only one expiry date, but there may be several proprietors and/or expiry dates on the card for different account configurations in some embodiments. In some embodiments the card may have several different emblems 130, 131 that typically relate to the IT networks through which the payment card can clear transactions. In some embodiments there is also a chip 110 on the payment card that may feature memory, and/or a small microprocessor. In some preferred embodiments of the invention, there are no double emblems, numbers or the like, the different financial service provider features are stored on the chip, and the card has just one number, expiry date, name and so forth as a usual credit card does.

On the other side of the payment card the card may have two different security codes 180, 181 or more, a signature sheet 160, and two magnetic stripes 170, 171 or more. In some embodiments the payment card only has one magnetic stripe which contains the data for the default account that can be used with legacy magnetic payment systems. It is also possible that there is only one security code 180, 181. In a special embodiment the payment card 10 is just like any current payment card today but the chip 110 contains access data that can be used to access more than one financial service provider and/or account.

In a particular embodiment, the issuer of the card puts different access data on the chip 110. For example the issuer can put VISA access codes and MASTERCARD access codes, and AMERICAN EXPRESS access codes or any other financial electronic network access codes into the chip 110 in one embodiment. In one embodiment it is possible that the issuer would choose the same card number, expiry, security code for all of these payment systems. The payment card will then be accepted by any of the aforementioned payment schemes.

Quite clearly the payment card may be a credit card, debit card, direct debit card, prepaid purchase card, or in fact any payment card in accordance with the invention.

In some embodiments the chip contains a list of priority that is used to rank the different payment systems. One exemplary list in accordance with the invention could be for example:

1) VISA

2) MASTERCARD

3) AMERICAN EXPRESS

In the priority list embodiment the payment card tries to clear the transaction first with the most preferred payment service, if this fails, then with the second most preferred payment service, and so on in the order of priority. If 1) signifies high priority, VISA would be chosen first in the above example. Quite naturally the priority list of preferred payment service providers might not read “VISA” on the card, but the payment service provider could be identified by a number and/or code or the like.

In some embodiments the payment service data is stored in the memory of the smart card chip, such as EEPROM, ROM, RAM or other like memory. The microprocessor on the smart card chip 110 is used in some embodiments to read the data from the memory and choose a payment service through which the transaction is set up.

In some embodiments there is a inventive computer server connected to a communication network. This computer server can be used to update data in the memory of at least one payment card. The update connection may be a wireline connection, such as a cable connection, and the smart card memory is updated whenever the payment card is inserted into a card reader that is capable of or arranged to deliver the update. In some embodiments the payment card memory is updated via a radio path. For example the memory chip part 110 of the payment card or the entire payment card can be inserted into a mobile phone in some embodiments. The mobile phone is used to receive a radio data update from a remote computer server, for example via Over-The-Air protocol or other data transfer protocol based on the GSM-, CDMA, Iridium, InMarsat, WCDMA, UMTS, or any other wireless data transfer protocol. It is also possible that data is updated on the smart card via an Internet-, Ethernet-, Bluetooth-, Infrared-, IrDA-, USB-, and/or wireline or wireless optical connection in some embodiments. The payment card may contain a radio transceiver or any other wireless communication link to obtain data wirelessly. In some rare embodiments the payment card may have a physical data connection socket for wireline data updates as well.

In some embodiments only the preference list or coded numbers indicating the preference list are sent and stored to the payment card memory. A multitude of price and/or service quality information may be rationalised at the server end to arrive at the preference list that represents a fair optimum of choices based on which the payment card clears transactions. The preference list may be optimised by the issuing bank for its own benefit or by the end customer in some embodiments.

In some embodiments a microprocessor on the payment card chip can control transaction setup from the payment card. In some embodiments the transaction is arranged with the lowest transaction cost to the buyer, seller, and/or lowest aggregate transaction cost for both. In some embodiments the transaction is set up so that it has the smallest transaction cost to the issuer of the card.

In one particular embodiment a bank issues the aforementioned payment cards to its customers. The customers typically have accounts in the bank that issued the at least one payment card. The issuing bank needs to pay all sorts of fees to the payment service companies (VISA, MASTERCARD, AMEX, etc.) for the use of the data network that clears the transactions. In one embodiment the payment card is arranged to setup the transaction so that the transaction cost is the smallest to the issuing bank.

This way the issuing bank can make the maximum profit and improve its competitive position against the international credit card/payment card companies. Whoever provides the cheapest data network to the issuing bank gets to clear the deals the customers of that bank make with their payment cards. The issuing bank can furthermore pit the payment service companies against each other: If the issuing bank feels for example VISANET charges too high fees, it can update MASTERCARD as the preferred payment service provider on the payment cards of its customers, by beginning to issue cards where MASTERCARD or the like payment network is preferred, or by updating MASTERCARD to a more preferred position in the existing issued payment cards, through a radio path update or via a data update pushed through a wireline network.

In some embodiments the payment card has a radio receiver embedded on it to receive data updates. In some embodiments the payment card is compatible with a mobile phone so it can receive e.g. a GSM SIM OTA update (similar to updating PLMN lists in GSM SIM cards for example) or any other radio update. In other embodiments a data update is pushed to card readers and whenever a payment card is inserted, the data update is written into the memory of the payment card, along with any other actions that were supposed to happen between the card reader and the payment card. The most preferred available payment service provider is taken as the first choice in preferable embodiments of the invention.

In one embodiment the data update is pushed especially to the card readers of ATMs (Automatic Teller Machines), and when the payment card is inserted into the ATM's card reader the payment card is updated in accordance with the invention. This is preferable in particular in situations where the issuing banks control ATMs.

In some embodiments it is possible that the use of some financial providers is blocked from the payment card by blacklisting these financial institutions. Say, Bank A of Panama charges very high transaction fees. In one embodiment the issuing bank places Bank A on a “prevented banks”-list in the chip in the payment card, like is the case with blocked roaming operators in GSM PLMN lists. Also some payment networks or deal clearing service providers such as AMEX, VISA and/or MASTERCARD might be blocked as explained earlier by putting them on a “access prevented” list.

For example suppose in one embodiment of the invention if the Payment card chip would have a file structure similar to a GSM SIM card, and suppose if 12345 would be the ID code of VISA and 67890 would be the ID code of MASTERCARD, and VISA would be a preferred payment service provider, whereas MASTERCARD would be a blocked payment service provider. In one embodiment of the invention “12345” would be sent in a radio and/or wireline update to the “EFPLMN_sel” file of the payment card chip, whereas “67890” would be sent to the EF_FPLMN file. Preferably the ID codes would be placed first in the priority list of both said files in some embodiments. Quite clearly in some embodiments payment service providers such as VISA or MASTERCARD could be replaced by banks such as HSBC, Deutche Bank or the like and their relevant ID codes in some embodiments. Background to one chip file system can be found from Joos Cadonau, OTA and Secure SIM Lifecycle management, which is cited here as reference.

Combining the aforementioned priority lists with a one account-multiple payment service providers is especially preferable. The payment card or reader can access the most preferred choice for executing the transaction, and all these transactions are consolidated into one account. This is very time and cost efficient to the user, as he automatically gets the cheapest or the best deal clearing service to his account, without having to consult multiple accounts.

In some embodiments the data on the chip is updated based on location of the payment card, for example when in Panama, Bank A gets put to the list by wireline or radio update.

In one embodiment, the chip 110 can be extracted from the payment card 10 in shape and size similar to a SIM card in the GSM mobile telephony system. In some embodiments this chip can be inserted into a mobile phone. When in the mobile phone, it may interact with the user through the user interface of the mobile phone. In some embodiments the chip 110 can be updated via the radio path of the mobile phone, or any other communication path accessible to the mobile phone. In some embodiments users can check data from the chip 110 via the screen and user interface devices of the mobile phone. In some embodiments the user can modify data on the chip card with the keyboard and other devices of the mobile phone or attached to mobile phone. In some embodiments the phone SIM card and payment card have the same PIN number. In some embodiments the user can charge calls onto the payment/credit card chip 110 when it is detached from the payment card and inserted into a mobile phone as a SIM card. In some embodiments all phone calls are automatically billed on the same payment card, thus saving time in bill processing and postage.

In some embodiments the payment card has a corresponding SIM-card on a separate chip. In some embodiments the chip 110 that is arranged to be used as a Subscriber Identity Module, is inserted into a card reader that is connected with a computer or a mobile phone. In some embodiments on-line purchases, or any purchases can be made more automatically, by card reader software extracting the necessary data from payment card chip. This way there is no need for the user to manually enter his payment card details when purchasing something over the Internet, for example. In some embodiments the seller's website is only arranged to show the details that were read from the card reader and then ask for the PIN. If the PIN is correct, the transaction is cleared.

In some embodiments the smart card chip 110 is construed to control the activities of the payment card, such as payment setup from the payment card, and the smart card chip 110 or a part of the smart card chip 110 is construed as a control means in accordance with the invention. In some embodiments of the invention the chip is used without the card-part independently as a payment card, for example within a mobile phone.

It should be noted that any features, phases or parts of the payment card 10 can be freely permuted and combined with embodiments 20, 30, 40, 50, 60, 61, 70, 80, 90 and/or 91 in accordance with the invention.

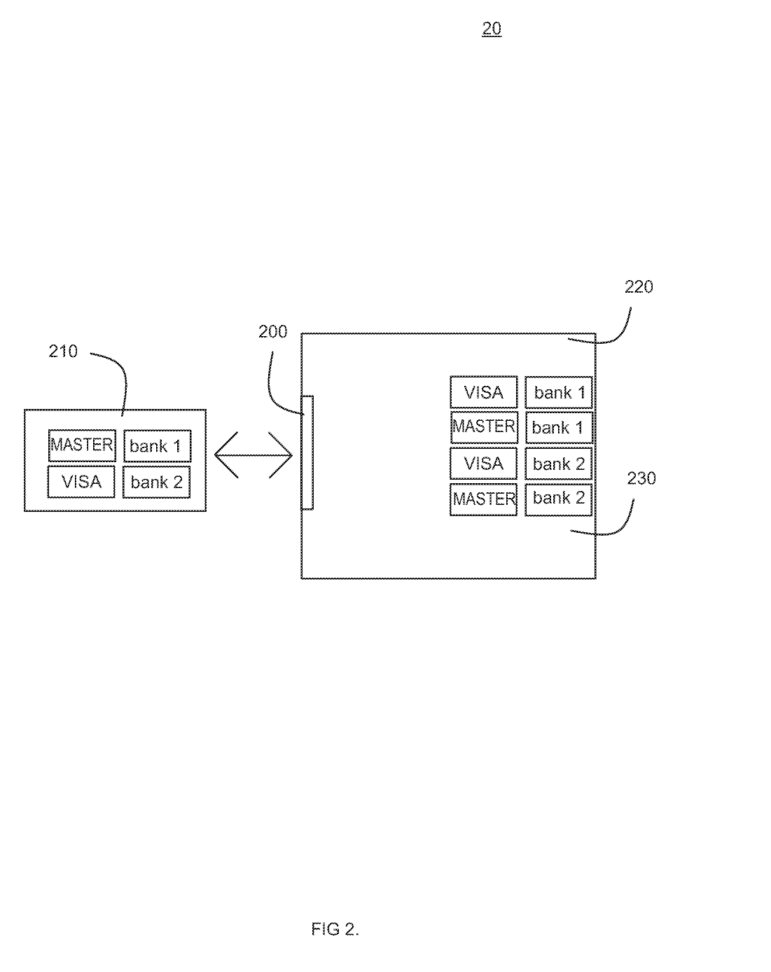

FIG. 2 shows an embodiment 20 of the payment card-card reader system. The payment card 210 is arranged to be inserted into the slot 200 in the card reader 220.

The card reader is typically operated by person and/or a company that wants to accept purchases and payments. In some embodiments the card reader 220 is arranged to feature access to more than one payment network, such as VISA and MASTERCARD. In some further embodiments there are multiple bank accounts that can be accessed by the card reader also. In some embodiments there is a multitude of bank account+payment network combinations (i.e. deal clearing service providers) that can be accessed by the card reader as shown in the FIG. 2. (4 different combinations).

The payment card 210 may also have different payment network and bank account combinations. One payment card may have for example a VISA account in HSBC and a MASTERCARD account in Deutche Bank in some embodiments.

In some embodiments when the card is inserted in the slot 200 the payment card and the card reader 220 read data from each others memories. Also it is possible and in accordance with the invention that just one or the other reads data from the memory of the other, i.e. card reader reads card memory, and/or card reads reader memory. The card reader, the payment card or both can use their memory and/or microprocessor devices to determine the best way to conduct the transaction.

In one particular embodiment the transaction is arranged with the lowest transaction cost to the buyer, seller, and/or lowest aggregate transaction cost for both. In some embodiments the transaction is arranged with the lowest transaction cost to the issuer of the payment card and/or the issuer of the card reader. In some embodiments the transaction is arranged with the lowest transaction cost to the bank or institution issuing the payment card and/or the bank or institution issuing the card reader.

In one particular embodiment, the card reader 220 and/or the payment card determine whether it is possible to conduct an intra-bank transaction, i.e. from a VISA account in HSBC to another VISA account in HSBC for example. The card and the reader will then preferentially conduct an intra-bank transaction in accordance with the invention if possible.

In many embodiments of the invention it is possible to update data in the payment card, card reader or both via cable, radio path and/or optical and/or IR data connection wirelessly or via a wireline connection. In some embodiments the card reader is equipped with a radio transceiver.

It should be noted that any features, phases or parts of the payment card-card reader 20 can be freely permuted and combined with embodiments 10, 30, 40, 50, 60, 61, 70, 80, 90 and/or 91 in accordance with the invention.

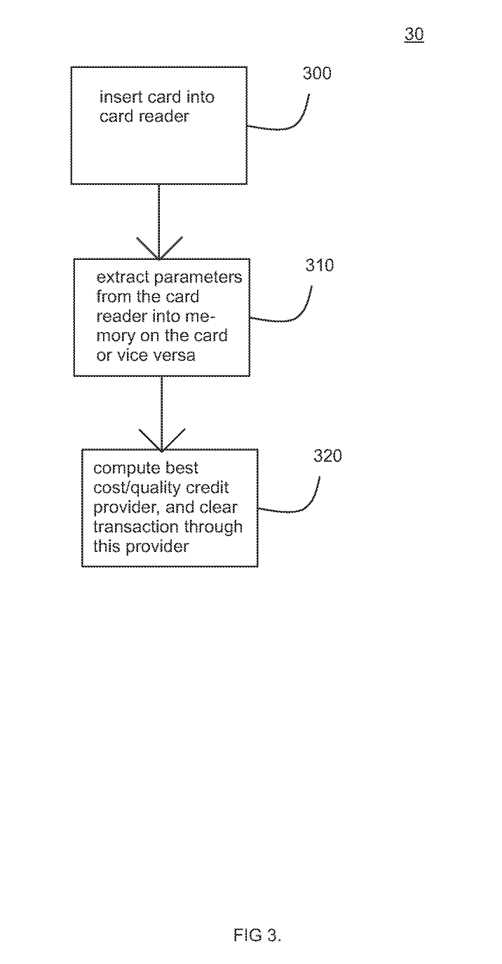

FIG. 3 shows an embodiment of the use of the inventive payment, inventive card reader, or both. To make matters clear it is possible and in accordance with the invention that the inventive payment card is used with legacy card reader systems. For example in one embodiment the inventive payment card just automatically pushes the first choice, i.e. the most preferred account and/or deal clearing service provider to the card reader when it is inserted into the card reader. Alternatives behind the first choice are only accessed if the first choice is not available or is rejected in some embodiments.

It is also possible and in accordance with the invention that the inventive card reader is used with legacy payment cards. It is naturally possible that the inventive payment card and card reader are used together in some embodiments.

In phase 300 the card is inserted into the card reader. Typically the card is inserted so that the chip 110 on the card enters the card reader slot 200. In phase 310 parameters are extracted from the card reader to at least one memory on the card, typically the memory is in the chip 110.

In some embodiments these parameters are update parameters, which are used to update transactional data on the card, for example the list of preferred transaction service providers as mentioned earlier. Any data updates can be done on the card before, during and/or after the transaction while a data transfer connection still exists between the memory on the card and the card reader. However, in many embodiments there is no need to update transactional data on the card all the time, the need for transaction setup data updates is commensurate with the price changes in the transaction clearing market. If the financial service providers change their transaction prices often, then the cards need to be updated often, but if not, the frequency of needed updates is less. In one simple embodiment only a list of number codes, each designating a deal clearing service provider or a bank are sent to the payment card memory and/or card reader. The list also indicates an order of preference in which the deal clearing service providers and/or banks are selected in a transaction situation. In phase 310 data needed to conduct the transaction is exchanged. In one embodiment of the invention the card reader reads the card and determines which modes of payment are possible. In some embodiments the reader will then select the cheapest mode of payment to the merchant in possession of the reader and execute the transaction based on that data. It is also possible that the card reader chooses the transaction mode that has the lowest cost to the buyer, the lowest total cost to the buyer and the merchant, or the lowest cost to the bank or institution that issued the card reader and/or an account to which the card reader relates to, for example by clearing transactions to that account.

In some embodiments the card reader reads a priority list from the chip 110 on the card and executes the trade with payment mode that has the highest priority and is accessible to the card reader. In some embodiments the card reader has a priority list of preferred institutions and/or accounts in its memory for clearing transactions. In some embodiments the card reader has a list for blocking institutions and/or accounts from clearing transactions. In some embodiments the card reader and/or payment card may look up any data, or preference list, from at least one remote server on the network.

In another embodiment in phase 310 the payment card may read the card reader and determine which modes of payment are possible. In some embodiments the microprocessor on the chip compares the payment mode options available in the card reader. If a payment mode is found on the card reader, and also on the priority list of the payment card in the chip, the payment mode with the highest priority on the list is selected. In another embodiment where the payment card sets up the transaction, the transaction is arranged with the lowest transaction cost to the buyer, seller, and/or lowest aggregate transaction cost for both. In some embodiments, the transaction is set up by the payment card so, that the transaction cost is the smallest to the bank that issued the payment card.

In some further elaborate embodiments the card reader and the payment card may exchange data to elaborate, and find a payment mode that both parties, the buyer and the seller, or their respective issuing institutions are willing to accept. In some embodiments the position of the actual buyer is iterated against the position of the issuer of the card reader and/or merchant, and/or the position of the merchant is iterated against the issuer of the payment card and/or the buyer. I.e. for example HSBC (Hong Kong and Shanghai Banking Corporation) and a barber business will have the card and the card reader electronically elaborating a mode of payment that is acceptable to both parties.

In phase 320 at least one best and/or acceptable payment service provider is determined by either or both parties in some embodiments of the invention, and the transaction is cleared through at least one payment service provider of choice. The choice is typically based on cost, but quality and/or cost/quality ratios may also be considered in some embodiments. Naturally conditions such as the speed of the transaction clearing, or error rate may affect the choice made by the payment card, card reader or both.

It should be noted that any features, phases or parts of the method 30 can be freely permuted and combined with embodiments 10, 20, 40, 50, 60, 61, 70, 80, 90 and/or 91 in accordance with the invention.

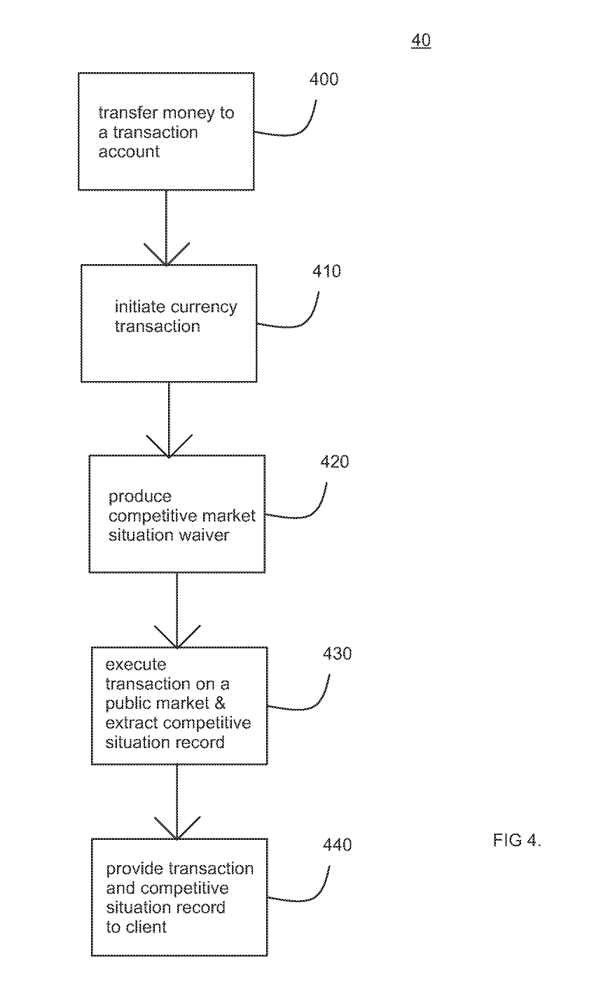

FIG. 4 presents an embodiment of the same inventive concept of increased transparency and competition applied to Internet bank transfers. In phase 400 the user transfers funds to a transaction account if there are not enough funds already there. In phase 410 a transaction is initiated which may be for buying or selling bonds, shares, commodities or any other marketable assets, or the like in some embodiments.

However, the invention probably works the best and has the widest application in currency trades in some embodiments. In particular the invention works the best in situations where real companies actually trade in real goods (i.e. non-speculative transaction). Whenever a real good is transacted and the buyer and seller are in different currency regimes, a currency conversion needs to be done by the banks transacting the deal in order for the payment to be delivered. As explained earlier, the companies/people are not typically fooled by excess in fixed fees that the companies can inspect. Instead, the absurd fees are typically generated by arbitrage, i.e. baked into the perceived exchange rate the company/person gets, which is more difficult for companies to inspect. This is made possible by the subsidiary structure used by bank groups, among other things.

The technical means & step that solves the information asymmetry problem between the end user and party conducting the transaction takes place in 420. In phase 420 a competitive market situation waiver is produced. A computer on the network that is operated by the party conducting the transaction typically produces the said waiver to the user through the Internet interface when the user is logged onto his account, or through any other typically electronic means, such as file exchange from computer to computer. In some embodiments the competitive market waiver is a PDF document that needs to be approved by the user, or it appears in a separate window in a type of “I agree to conditions/I do not agree to conditions”. The competitive market waiver can be collected from the user of the system by any technical means, such as a phone call, letter or the like in accordance with the invention. The competitive market waiver can be of different legal types, it may be a Power of attorney (POA) to the transacting party to transact on competitive markets on behalf of the user, or it may be a conditional agreement to allow a trade between the user and the transacting party, provided the competitive market situation of that trade in a competitive market is verified and justified later. The first case is very clear, the transacting party simply trades under the POA for the user, and delivers the competitive record later. The latter case is also quite simple, the transacting party and the user do the trade at a price, and the transacting party justifies that price by the competitive bidding record from a competitive market. In practice in many embodiments, the transacting party will just do the trade with the user, and immediately float it on the open market, and provide the competitive bidding record from the open market to the user to justify and verify the trade they did. This is the type of pseudo-own-account trade. The transacting party trades on its own account, but is required to prove to the user that he has not cheated by taking arbitrage. In some embodiments of the invention, the computer server performs all these actions in a matter of seconds, and the trade and the competitive record will appear to the user account statement in a matter of seconds or fractions of a second.

In the POA embodiment, the user agrees to a fair market price and/or exchange rate without prior knowledge of said market price and/or exchange rate. Sure, it is possible for the user to look up past quotes from e.g. the Internet, but in reality he does not absolutely and/or exactly know what the price will be. In the pseudo own account trade, the quote being given to the user has to match very closely with trades being performed in the market, so the two won't deviate to create a large difference. Preferably the quote is updated in a matter of seconds or minutes, not once per day as is the current frequency in Internet bank terminals in the EU.

The primary need for the waiver is to be a matter of record. In some embodiments the user permanently signs the competitive market waiver for all transactions or for all transactions for a certain unit of time, or for a certain group of transactions. This could be stored at the transaction server in user settings so there is no need for the system to ask the user to reply to waivers on a case by case basis.

The competitive market waiver, or the corresponding setting, retrieves the approval from the user that the transaction is conducted under special conditions: free market conditions. In the waiver the user gives up all his rights to any compensation or damages should the whole capital used in the transaction disappear. In other words the user takes all the risks, in exchange for the promise that the transacting party will float and execute the transaction on free markets. The fee is then charged for this service, in most embodiments. As the user takes the risks, he can expect lower cost. It is true that there is a possibility that a meteor may hit the United States or the EU leading to the complete abolition of the US dollar or the Euro. If the EU would be destroyed in the next 5 minutes, the EUR-USD exchange rate being currently 1.51, it might be a good idea to take the rate of 1.49 being offered by the bank terminal when sending 2000 USD from the US to a party in France. However, is approximately 40 USD (0.02*2000 USD) really a reasonable fee for the insurance that a meteor does not destroy the EU in the next 5 minutes, or generally that the market does not turn for the worse? After all, it is quite probable that the EU is still there even after ten minutes and the euro is trading quite close to USD where it was, and banks both in the EU and US know this very well.

However, as the competitive market waiver has been obtained, there is no reason for the transacting party to offer any exchange rate at all (exception being the pseudo own account trade). The user has already accepted that whatever the rate, he will accept it, provided free market conditions prevailed. If a meteor indeed hits the EU, and everybody is buying dollars, he will still take them (the euros) at the market rate, no matter how much their value is expected to drop in the very near future. In preferred embodiments of the invention the requirement of the user is simply that the transacting party proves that the deal was fair (i.e. did not include arbitrage), even if this is to be done afterwards.

In phase 430 the computer system of the transacting party executes the transaction on the public market and extracts the competitive situation record. This record will prove that the deal was fair. The actual price only tells what the price was. Typically the record will show the competing bids that were available at the time the transaction was made. It may also provide other data, such as the parties making the bids, their sums, or any other relevant competition data, which preferably can be inspected in accordance with the invention. The record may list only one bid, two bids, or indeed any number of bids. In one preferable embodiment a few exemplary competitive bids are incorporated into the account statement of the user in addition to and preferably next to the actual transaction. From this account statement, in electronic and/or paper copy form, the user can conveniently inspect the competitive positions of his transactions, and thus further inspect that no unfair arbitrage has been taken from him.

Typically in many preferred embodiments of the invention the competitive transaction record is sent to the user via Internet, email, post, fax or any other feasible method in phase 440. The user may then scrutinise the performance of the trade and its cost to the prevailing relevant market conditions at the time of the trade.

The aforementioned technical system for transacting deals electronically is especially suited to markets which trade in arguable non-assets, such as currencies. Currency could be described arguably as not even an asset class, because it is a zero sum game. The invention provides a special advantage in this use embodiment, because minimising fees paid to middlemen & speculators is a primary concern for parties that simply want to enter and exit the market, rather than trading actively on it. As explained above, the transaction server does that with the minimum real cost and maximum end transparency. It should be noted however, that the systems of the invention are applicable for any electronic market, stocks, commodities, real estate, any futures, any options, bonds, insurances, swaps, credit default swaps, leveraged instruments, securitised loans or the like.

In a preferred embodiment applied to the currency markets the transaction server will routinely issue price requests for certain blocks of currency that the user has entered into the system with a competitive waiver in force. Preferably the transaction server will send these requests to institutions that are market-makers, i.e. institutions that have to provide a rate for that currency pair. Preferably, the transaction server does not specify which way the deal is done, i.e. whether buying or selling. Ideally in some embodiments the system requires a liquidity provider to come up with the currency pair number, and only then specifies which way the transaction will be completed i.e. buy or sell. Now suppose Deutche Bank and HSBC, both assumed market makers, come up with EUR-USD pairs of 1,495 and 1,490, respectively. There is a David Smith from Kansas, US sending 2000 USD to his son Charles in Ecole in France, and a Helmut Merkel sending 1500 euro to his daughter Nadine who is in college in Arizona, US. What will the transaction server of the invention do? The transaction server will put David Smith's order against the bid from HSBC and sell USD at 1,490 and get the maximum amount of euros for Charles. Helmut's 1500 order is placed against the bid from Deutche Bank, with an order to buy dollars. The end result is that Charles gets 2000(1/1.49−1/1.495)=4 euros more, and Nadine gets 0.005*1500=7.5 USD more. The trade for Charles will go into the competitive record provided for Helmut and Nadine and the trade for Nadine will go into the competitive record provided for David and Charles. Everybody has won in accordance with the invention, except the banks who missed the opportunity to do the deals the other way around and take the money from both Nadine and Charles in arbitrage.

It should be noted that the mere recording and production of the competitive record is hugely important, even if it were never used. The mere fact that the record is being produced provides a high disincentive to cheat or exaggerate the cost to the transaction party. It should also be noted that competitive situation waiver is also hugely important. In some embodiments and some jurisdictions the transaction party cannot conduct the trade without it without trading entirely to its own account, which is precisely what the invention tries to avoid because it increases opaqueness in the financial system. With the current invention real people and real companies can connect to the large markets of the world at their own risk without paying premiums for insurances that the banks mandatorily couple with any purchase that gets made in their proprietary systems.

It should be noted that the competitive situation waiver does not and should not be all inclusive. It should be beside the point if Helmut's US based uncle would have come up with a bid of 1.55. The competitive situation waiver should pertain to a known market that is competitive and that the server can access in most embodiments of the invention.

According to the current knowledge of the inventor, only transaction above 1 million USD may be entered to the Interbank market. Therefore it is in accordance with the invention to aggregate payments together to overcome size limits and increase efficiency. In some embodiments where the users payment is aggregated with other payments, merely the payment and/or the part belonging to the user is reported. Other parties within the same aggregate payment could be held secret for information protection and privacy reasons.

There are many transactions or payments that can be taken from the Internet bank terminal or the customer account of the transaction server that involve several trades. For example, if a Finnish customer purchases shares from NASDAQ, there will typically be a currency trade from EUR to USD and a share trade to purchase the shares. It is in accordance with the invention to capture separate competitive records of one or more available bids in the market at the time of the transaction for both the currency trade and the share trade. In some embodiments these separate competitive records are consolidated to one competitive record that is arranged to verify the transaction cost of each trade and/or the aggregate trade, for example on an account statement, electronic and/or paper form in accordance with the invention. Therefore the nominal cost and any arbitrage and/or opportunity for arbitrage are both reported for each subcomponent separately, and/or in some embodiments of the invention they are reported in compound form. The bidding record of the invention is arranged to reveal any cost, any arbitrage and/or any opportunity for arbitrage in cases where there is at least one bidding record on one or multiple trades. The aforementioned holds for aggregate trades also in some embodiments of the invention. Therefore, in accordance with the invention, the cost of executing the transaction may involve or be understood to involve any of the following costs in any combination: any cost, any percentage or absolute cost and/or any arbitrage or spread and/or any opportunity for arbitrage or spread.

In preferable embodiments of the invention the competitive record is captured at the same point in time as the transaction is made, preferably within the same second, 5 seconds or within the same minute. The effect of the invention begins to diminish as the time period between the transaction and the capture of the competitive record grows. Sometimes even within a day the markets have moved so much that high levels of arbitrage can be hidden into the reported price. In a compound transaction involving two or more transactions, the capture of the competitive record should take place very close in time to each trade itself. For example if in the preceding paragraph the currency trade takes place at 11:06 and the share purchase at 12:37, the competitive record for the currency trade should be captured preferably very close to 11:06 and for the share purchase the competitive record should be captured preferably very close to 12:37. In preferable embodiments of the invention the time difference between the transaction and the capture of the competitive record is short enough that the price volatility remains small compared to the charge for the transaction service. If the price changes by 1% in an hour, it is impossible to prove that there was no arbitrage taken if the service fee is 0.1% and the transaction and the capture of the competitive record are 1 hour apart. However, if the said time difference is only 1 second, hiding the arbitrage into volatility becomes much more difficult. Of course the trade can still be badly placed within that second of market activity. However, it should not be systematically badly placed all the time over great numbers of transactions, if that is the case, the trading party is either not trying very hard to secure favourable trades or cheating.

In some embodiments of the invention the capture of the competitive record takes place before the transaction, in other embodiments the capture of the competitive record takes place after the transaction in accordance with the invention.

It should be noted that any features, phases or parts of the method 40 can be freely permuted and combined with embodiments 10, 20, 30, 50, 60, 61, 70, 80, 90 and/or 91 in accordance with the invention.

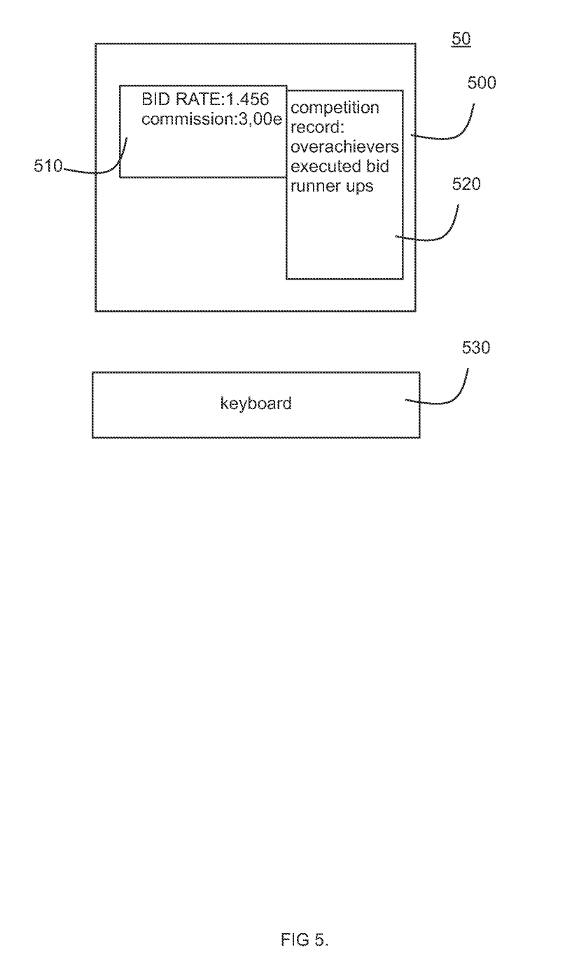

FIG. 5 shows an embodiment of the user interface 50 for operating the invention from the customer end. In this embodiment the user is viewing his transaction/payment account, or credit card account statement or any statement that records his deals. In this embodiment he views the user interface from a computer screen 500, and operates the system with a keyboard 530, and possibly a mouse or any other control means (not shown).

The screen now shows the user viewing his euro payment to the USA, which of course gets converted to dollars so a currency trade needs to take place. The account statement 510 will show at what rate the deal was done, and the commission, which may be a flat rate that is typically better understood by consumers. However in some embodiments it may be a percentage or a combination of a flat fee+percentage. This is not the point, the main point is that the price of the work that the transaction party did is disentangled from the actual exchange rate. Now in addition to the actual deal 510, a further window 520 opens that displays the competitive record that was obtained when the transaction was made. In most situations in a free market, everybody cannot get the best deal. That is why the competitive record will typically show deals that were on the market and were executed on the market with more favourable terms, i.e. the “overachievers”. These are just transactions that were better placed in terms of size, conditions or any other factor that the main market transacted to between those two parties instead of involving the user as one of the parties. In this case a overachiever bid could be 1.46, providing 0.004*(euro payment) of dollars more. The runner up could be 1.453, providing 0.003*(euro payment) of dollars less. The fact that others got a better deal is likely to upset the user viewing the record, but such is life. Occasionally, and indeed most of the time for most people, you need to be happy with the second or third best, or indeed 500^{th} best, because that is what other people offer on the market and if you do not take it, you'll be worse off further still. For most parties who understand this reality of the markets it is not a problem. As long as the executed bid is somewhere in between good and bad, i.e. there are worse bids that might have been taken, the executed bid is likely to be a fair outcome of competitive struggle in a market that genuinely pits strong independent players against each other. In a market like this everybody gets a de facto fair price, and it is impossible to cheat.

The user also has the benefit over time of having these records in some embodiments of the invention: he can compare his position in the competitive record, which should be a random walk over time. In some embodiments there is a random walk program that fits a statistical model of the position of the executed bids in their competitive landscape. The user's suspicion should arise if he is systematically at either ends of the competitive record, always a poor performer or always a great performer. If this is the case, it is quite probable that someone is cooking up the deals at the transacting party, and possibly falsifying records. For many practical purposes, the competitive landscape history is a better objective test of whether the end user has been fairly treated by the transacting party, rather than a financial regulator opinion, which of course, is only an opinion.

Quite clearly, the user interface can be used with any electronic device such as a computer, laptop/palm computer, mobile phone and/or a TV in accordance with the invention.

In some embodiments the invention works well in liquid markets. When markets are liquid, like the currency markets, automatic flotations are easy and reflect the truth in the marketplace. This can be a different story if the market is very illiquid. If everyone wants simply a fair market price, without saying what it is, the market will stop, because there is no number, i.e. price to trade at. In some embodiments the transacting system may simply guess numbers and put them onto the marketplace just to get the trading to begin. In some embodiments the guess can be based on past market performance or expected future market performance. I.e. when there is a systemic open offer trap, i.e. everybody is open to offers but no one is making any offers, the trading can be resumed by a guess at the reasonable market price in some embodiments. The guess can be computer or human generated in some embodiments of the invention.

It should be noted that any features, phases or parts of the computer system 50 can be freely permuted and combined with embodiments 10, 20, 30, 40, 60, 61, 70, 80, 90 and/or 91 in accordance with the invention.

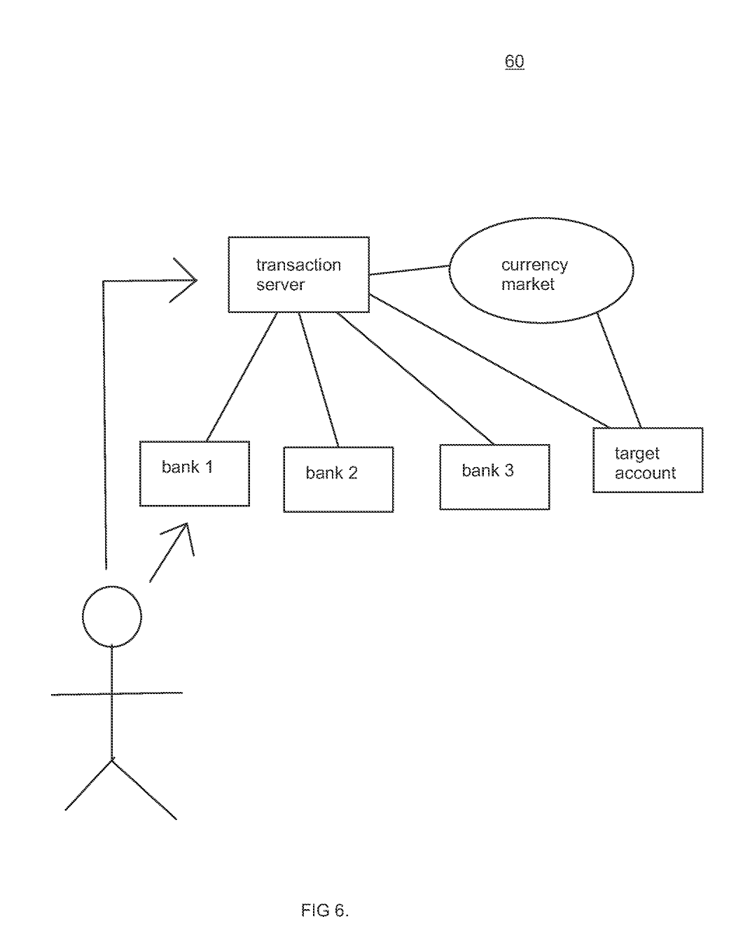

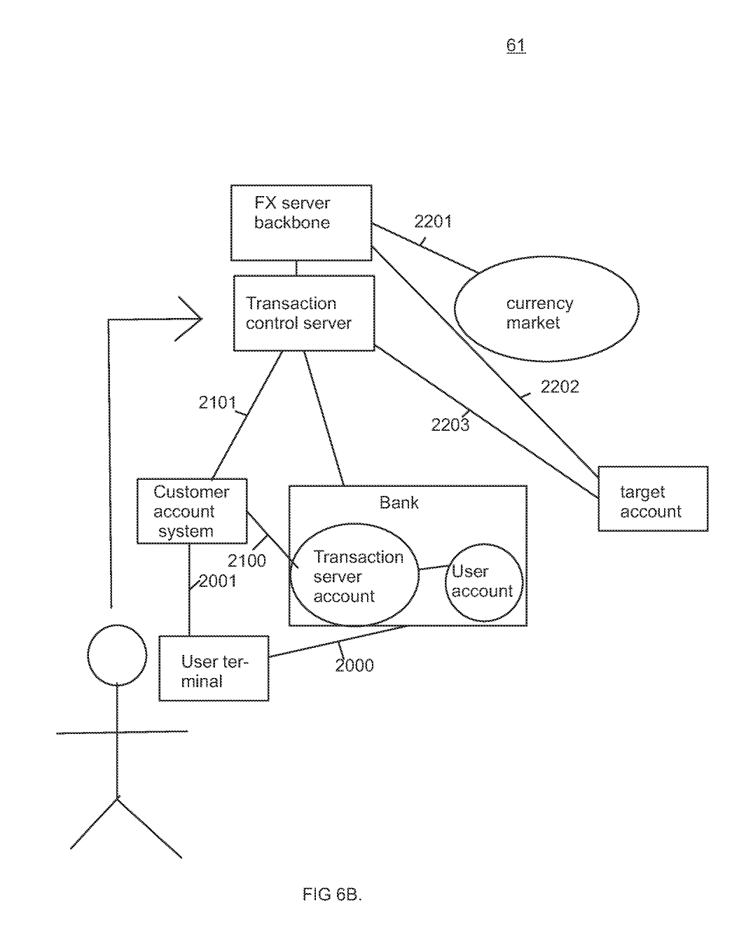

FIG. 6 shows the computer network as a block diagram used to carry out transactions with the method 40. The transaction server typically has accounts in many major banks, typically also in the same baseline currency. For example for Finnish customers the accounts would be euro accounts in Finnish banks, irrespective of where the transaction server resides. When the companies or people transfer money to the transaction account from their accounts with banks 1, 2, 3 the money will typically show immediately at the customer's transaction account at the transaction server.

A user can simultaneously be logged onto his own bank account at say bank 1 and the transaction account associated with the transaction server, e.g. via the Internet in some embodiments. Thereby the user can bypass the transaction machine of the bank and access the larger market. Ideally, in the case of a payment involving more than one currency this would be the gigantic Interbank market. In order to be able to participate into the Interbank market the transaction server needs to be operated by a party entitled to access the said market. It is in accordance with the invention to enter the market through any reasonable technical and/or legal communication channel. In a particular embodiment in some jurisdictions the access to the Interbank market is restricted by size, so it might be difficult for the operator starting the transaction server to begin operating. In some embodiments the transaction server is automatically arranged to generate transaction and competition waiver data for statistical purposes, and even in some embodiments for the purposes of generating data and/or evidence for a court order and/or regulatory authorisation to enter and keep connecting to the Interbank market. This automated record collecting technical feature is useful in scenarios where existing power players in the business try to inhibit competition unlawfully by trying to shut the transaction server out of deals that would offer preferential benefits and/or advantages when executed.

The transaction gets delivered to the target account directly by the transaction server if it has access to that account, or through an intermediary and/or recipient bank. Preferably the transaction server minimises the cost charged by the available intermediary and/or recipient bank in some embodiment.

In one embodiment the transaction server is a computer server that has account management software associated with its accounts in most major banks. Alternatively or in addition it may have its own account system where customers can deposit money. In some embodiments the transaction server account in its own account system is carried forward immediately when the customer transfers money to the transaction server account in the bank. This embodiment typically works best when the user and the transaction server both have accounts in the same bank in accordance with the invention, as the intra-bank money transfer is typically instantaneous.

In one embodiment the transaction server reads its accounts in all major banks and as soon as it receives a payment to its account in that bank, it credits the customer account system of the party that sent the transaction or for whom's account the transaction was sent. In some embodiments there is a reference number or the like in the message part of the bank transfer or elsewhere in the bank transfer that is immediately recognised by the transaction server and/or customer account system, and based on this reference number or the like the intended and/or correct customer account in the customer account system is credited immediately. For example a payment of 100 euros with a reference number of 0000051 to an account being read by the computer system of the invention would lead to crediting the customer account 0000051 with 100 euros in some embodiments of the invention.

The customer account number may also be paid directly to in some embodiments of the invention as a bank transfer. In this embodiment the customer account could be a regular bank account in accordance with the invention. The transaction server system and/or the customer account system can naturally be operated by anyone in principle, for example by a bank or a corporate treasury and/or fund in accordance with the invention.

Further the counterparties to the trades are typically arranged with a computer system that connects the transaction server accounts and transaction from them to deep liquidity (i.e. large treasuries and banks). In one embodiment of the invention the transaction server is incorporated with FXALL (www.fxall.com), or a like electronic neutral transaction and/or liquidity provider. The bidding record is captured from the competitive landscape that is available in FXALL or the like global trading system when the trade of the customer is executed and reported to the user interface of the customer or customer's account or any other reporting means, even a fax or a letter in some embodiments.

It should be noted that any features, phases or parts of the computer system 60 can be freely permuted and combined with embodiments 10, 20, 30, 40, 50, 61, 70, 80, 90 and/or 91 in accordance with the invention.

FIG. 6B shows an embodiment of the transactions server system 61 of the invention in use where a non-professional financial user, such as a consumer or a small or middle sized company or indeed a large company without a financial markets function, can access global deep liquidity markets from a user interface that is easy to use, available all the time, cheap to install, and most importantly financially transparent, offering low transaction costs that can be verified without fear of unfair arbitrage. The user uses the user terminal which is typically a computer or a mobile phone with a electronic communication connection such as an Internet connection. The user logs onto his normal Internet Bank with the bank he has his account with via connection 2000, which is typically a electronic secure Internet connection that employs keyword and PIN code identifications and the like. When the user accesses the User account he can transfer money to a Transaction server account that is typically controlled by the party running the transactions server system. Preferably, but not necessarily, the Transaction server account is in the same bank as the User account. In this instance the money transfer will be credited to the transaction server account immediately, typically in a matter of seconds, whereas otherwise it might take a business day. The customer account system reads the Transaction server account via connection 2100 and as soon as it identifies a payment made to the account it will credit the payment towards the customer account to which the payment is made. In some preferable embodiments the user has a reference number and/or reference message or the like, that is automatically recognised by the customer account system and credited to the account associated with the reference number and/or reference message or the like.

Quite clearly the bank accounts and the customer accounts can be in different jurisdictions and physical locations in a different or the same computer in different physical locations. Any part of the invention can be placed on the same computer server with any other part, as well as it can be distributed with or without other parts of the invention on one or multiple computer devices. However, it should be noted that the bank accounts in normal banks are typically technically under the control of the banks, with the transaction server owning and having the ability to control the account, but not its physical and/or technical character, besides user specified settings. It is completely normal way of operating the invention to have a computer server in Helsinki, Finland, reading a bank account in SunTrust Bank in Alabama and crediting any money paid into the Alabama account to a Japanese company in the customer account system that may be hosted on computer servers in China, but which customer account is accessed by the Japanese company in an Osaka office building. The customer accounts need not be in a bank in some embodiments, but in other embodiments the customer accounts can be bank accounts in which case the party controlling them typically operates under a banking license.

The user will now access his customer account in the transaction server system via connection 2001, which is a electronic connection, typically a secure Internet connection with password and number identifications a PIN (Personal Identification Number) number list and/or other security measures such as data encryption and decryption in place. The customer account system will show the user his account and a typical Internet or electronic account management user interface. Especially the user will be shown or the user can select a interface for entering international payment details, such as IBAN number, name of recipient, address of recipient, SWIFT/BIC code, account number, recipient bank, recipient bank address, amount of money being transferred, currency used, reference data or invoice identifier, who pays transaction cost (both their own expenses, sender, or recipient) and other data and options.

The user enters the aforementioned payment details normally, similarly to an Internet bank terminal commonly in use, at least in most Nordic countries. During some stage of the payment preparation competitive market situation waiver and possibly a Power of attorney will be presented and requested to be electronically signed or approved as explained in embodiment 40 earlier. Signing documents can be done electronically by ticking a box, providing scanned signature, providing biometric identification, such as fingerprint and/or retina scan or the like, but most preferably the identification is by password and PIN number lists. Once sent, the payment is sent to the transaction control server electronically via connection 2101. In some embodiments the Transaction control server and the customer account system are physically in the same computer and/or memory storage device. The transaction control server performs the currency trade using the FX server backbone, which is typically a computer network to which currency market liquidity providers, such as large banks and treasuries are connected to. The transaction server conducts the needed currency trade and/or trades to arrive at the desired target currency and amount, and captures the bidding record from the market that contains at least one bid as explained in embodiment 40. The transaction control server then sends the desired amount in the correct currency to the target account directly via a electronic communication connection 2203 and/or it instructs the FX server backbone network to credit the target account via connection 2202. Any computer servers or terminals of the invention may reside on one or multiple physical computers.

The transaction control server then deducts the payment from the customer account from the customer account system. In addition a fee for the service may be deducted from the customer account. Importantly, the bidding record of the market at the time of the trade will be produced for inspection in the customer account system as explained in embodiment 40. This will allow the user to inspect the service fee reliably. Naturally the customer account system may feature many other internet bank features, such as receipt production, viewing and storage and the like.

In some embodiments the customer account system displays advertisements to the user. These advertisements can be profiled based on the financial behaviour of the user and therefore be very effective. The advertisements can be shown with an electronic banner on the computer screen, or information can be emailed or posted and/or otherwise delivered to people and/or companies based on contact details in the customer account system. In some embodiments the transaction server does not impose any service fees on its users at all, but collects its operating income from advertising only.

It should be noted that any features, phases or parts of the computer system 61 can be freely permuted and combined with embodiments 10, 20, 30, 40, 50, 60, 70, 80, 90 and/or 91 in accordance with the invention.

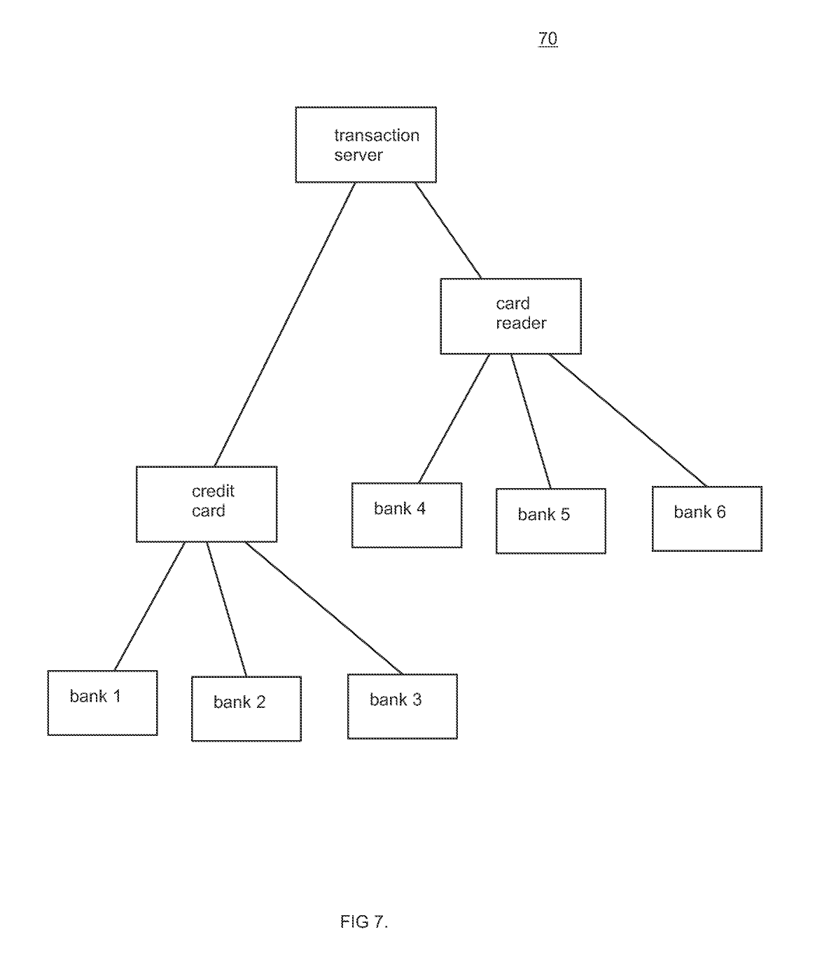

FIG. 7 shows the system of mobile payment devices with the transaction server. The transaction accounts of the transaction server may be associated with a payment card in some embodiments.

In these preferred embodiments the payments that were paid with the payment card and/or accepted with the card reader are transacted with the method 40 in some preferential embodiments.

In other embodiments transaction server may be arranged to control transaction setup from the payment card or card reader based on control data that it may provide to the payment card and/or card reader, through updates or no updates in some embodiments of the invention. Typically in some embodiments the transaction server observes the market bids the different financial service providers provide in the open market. The transaction server may follow charges that are borne by customers and/or businesses in some embodiments. Based on the provided market prices and charges the transaction server can decipher which financial service providers offer the best end terms to end users for their respective deals.

In some embodiments the transaction server resides with a bank. In that particular embodiment the transaction server may be arranged to minimise the costs being paid to other banks for money traffic, by intelligently controlling the transaction setup from the payment card and/or the payment card reader in some embodiments.

It should be noted that any features, phases or parts of the computer system 70 can be freely permuted and combined with embodiments 10, 20, 30, 40, 50, 60, 61, 70, 80, 90 and/or 91 in accordance with the invention.

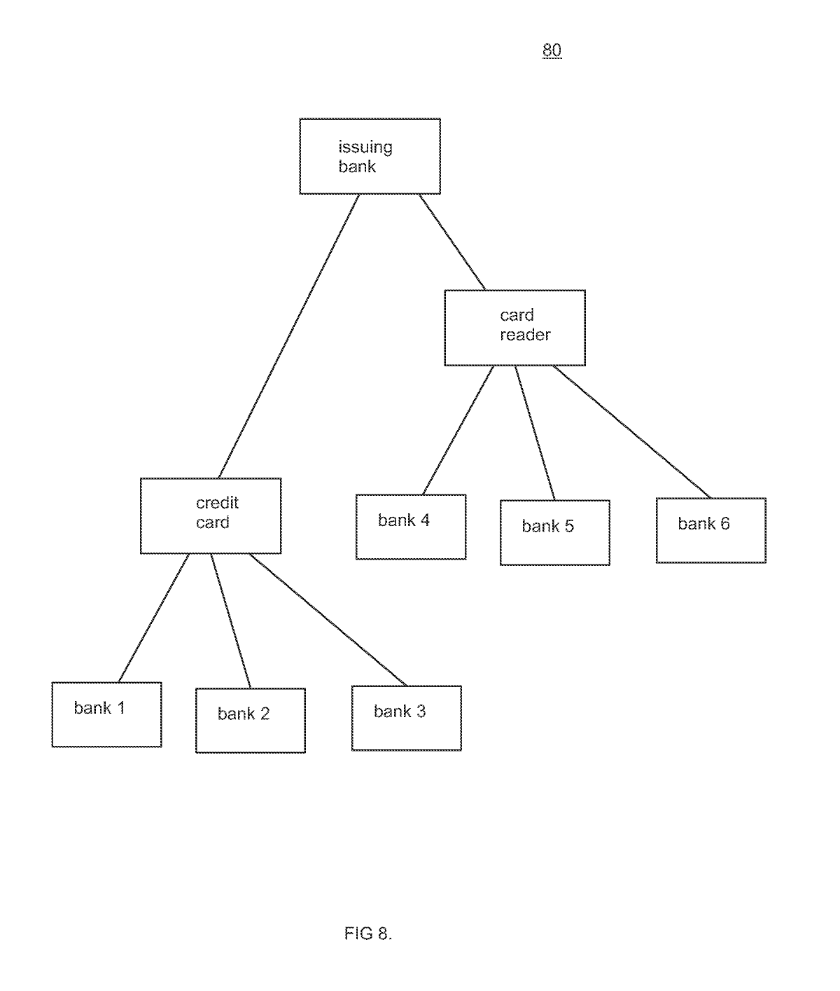

FIG. 8 shows an embodiment where an issuing bank uses the invention to cut production cost of financial services. The issuing bank will update any data pertaining to transactional traffic, such as price data, service quality data or the like to the card readers and/or payment cards it issues in some embodiments. In some embodiments the issuing bank maintains preference lists in both the card readers and the cards. The preference lists preferably feature those other banks, credit card companies, and/or payment network companies that provide preferential and/or cheap rates to the issuing bank. In some embodiments the issuing bank puts itself as the first choice in order to execute as many transactions as intra-bank transactions as possible.

In most embodiments the companies that charge the issuing bank the least are featured on the preference lists and/or in the data, and these are used more often than other companies in order to control the transactional costs that other companies besides the issuing bank get. In some embodiments, for example in the case of the issuing bank having subsidiaries, the preference list and/or data may feature subsidiary companies. For example if banks 1, 2, 3 are subsidiaries of the issuing bank, the payment card may be updated to prefer banks 1, 2, 3, over any other bank in some embodiments. Also if bank 4 provides the cheapest transaction traffic costs to the issuing bank, it may be selected as the first choice when available. In some embodiments the banks 1, 2, 3, 4, 5, 6 may be replaced by payment network and/or credit card companies such as VISA, MASTERCARD, AMEX or the like in accordance with the invention. Also in these embodiments the issuing bank typically puts the cheapest credit card company, deal clearing service provider and/or payment network as the first choice.

It should be noted that any features, phases or parts of the computer system 80 can be freely permuted and combined with embodiments 10, 20, 30, 40, 50, 60, 61, 70, 90 and/or 91 in accordance with the invention.

It should be noted that in all embodiments the payment card can be updated with new data pertinent to the preference order. The update may take place via an independent radio connection or cable connection, or be arranged to happen when the card is inserted into the reader by the reader writing electronic data into the memory of the payment card. In all embodiments the payment card may be inserted into a mobile phone for updating data. Similarly in some embodiments the card reader may be updated with data pertinent to the preference order. The update may take place via an independent radio connection, other wireless connection and/or cable connection and/or other fixed connection. In one embodiment the card issuing bank processes number codes of deal clearing service providers such as VISA, AMEX, MASTERCARD or the like and sends the list of these said number codes in an order of preference to the payment card in the aforementioned update, as explained with FIG. 1 and embodiment 10 earlier. In this embodiment the issuing bank puts itself into the position of the home operator in a GSM roaming administration system.

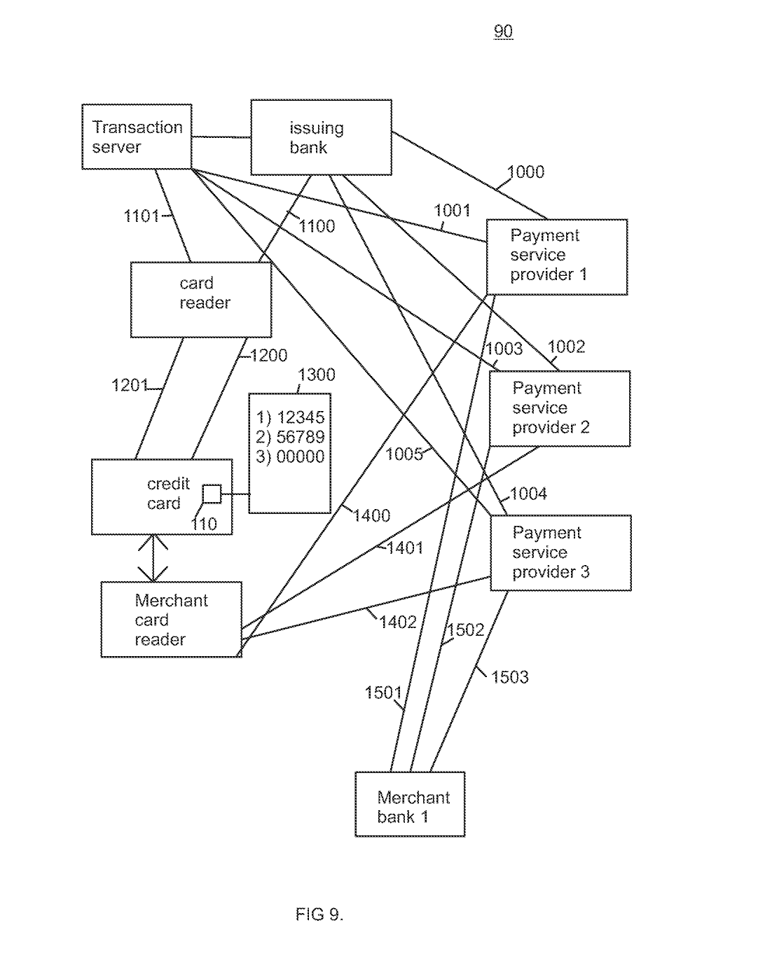

To make the earlier payment setup control method from the payment card perfectly clear, FIG. 9 shows a preferable embodiment of the invention. The issuing bank issues credit cards to its customers, and therefore controls a fleet of payment cards that are physically out in the markets with the consumers. The payment card comprises a chip 110 as said before. There is a transaction server of the invention, which is computer server that can have communication connections to the issuing bank, to at least one payment service providers 1, 2 and 3 (such as VISA, MASTERCARD, AMEX or the like) and to one or more card readers or payment cards. The transaction server can be a separate computer system hosted by a third party, or it may simply be a computer server in the infrastructure of the issuing bank. The issuing bank and/or the transaction server collect service information from payment service providers via at least one connection 1100, 1001, 1100, 1101. The connections can be electronic wireless or wireline connections, radio connections or they may employ the errand boy—principle, i.e. a messenger or a business man simply goes from the issuing bank to the payment service provider and extracts the service information concerning prices, service quality and availability and/or other service information by negotiation or otherwise. Naturally the errand boy connection may work the other way around as well, with payment service provider salespeople or consultants visiting the issuing bank. The payment service providers are electronic payment network operators, such as VISA and its electronic payment network VISANET, MASTERCARD and its electronic payment network, AMEX (American Express) and its electronic payment network or any other electronic payment network or networks and so on. Alternatively or in addition payment service providers may also comprise any bank or its electronic computers that is/are used to provide the payment service to clear the transaction or otherwise progress the transaction.

Once it is known which Payment service provider provides the most competitive offer to the issuing bank and/or to the customers using the credit cards, this payment service provider is made as the preferred choice, the 2^{nd} most competitive offer as the 2^{nd} most preferred choice and so on. The payment service providers may have code IDs designating their networks, similarly or analogously to how the GSM operators have Operator ID codes to designate their cellular networks: E.g. as in the command at*epnr=2 outputs GSM Operator ID codes from the SIM card chip memory, for example *EPNR: 3,“26202”=“Vodafone−Germany”, meaning that Vodafone−Germany network operator is the third most preferred roaming operator for the purposes of providing a guest network, and has a GSM Operator ID code of 26202.

If payment service provider 1 provides the best deal to the issuing bank and/or customers, and suppose its network has a ID code 12345, this code will be put into the first place in the preference list 1300 stored on the chip 110 in the payment or credit card. This preference list can be updated from the issuing bank or from the transaction server in various embodiments of the invention. The update to the chip 110 can take place via radio path or via a wireline connection. In one embodiment the issuing bank and/or transaction server sends a wireless, wireline and/or radio update to a card reader which may be hosted in an ATM, bank branch, mobile phone and/or computer.

Next time when the credit card is inserted into a card reader to make a payment, it will try to make the payment via the preferred payment service provider, if this is not possible then the second most preferred and so on. It is in accordance with the invention for the payment card chip 110 to couple different customer data to the payment transmission if a different payment service provider is chosen. In many embodiments the name of the payment card user is likely to be the same or similar, but the payment service provider 1 may have a different e.g. credit card number and/or expiry date than payment service provider 2.

It should be noted that the transaction server may have variable roles in this embodiment. It may be a similar transaction server as in earlier embodiments, added with the functionality of collecting service information pertaining to price, quality, and/or creditworthiness of payment networks, and sending this data in priority list or other form to the payment card chips 110 or card readers. This embodiment has synergies, as the transaction server is already awash with market data that could be used to compose, or be included in, the said data updates.

In some embodiments of the invention, however, the transaction server does not have any capability to capture competitive records mentioned earlier. In this embodiment the transaction server merely collects service information from payment service provider means and/or deal clearing service providers and sends all or some part of the service information, in one format or another to the payment card chip and/or the at least one payment card reader. The transaction server may format the collected data in multitudes of ways in accordance with the invention.

It should be noted that any features, phases or parts of the method 90 can be freely permuted and combined with embodiments 10, 20, 30, 40, 50, 60, 61, 70, 80 and/or 91 in accordance with the invention.

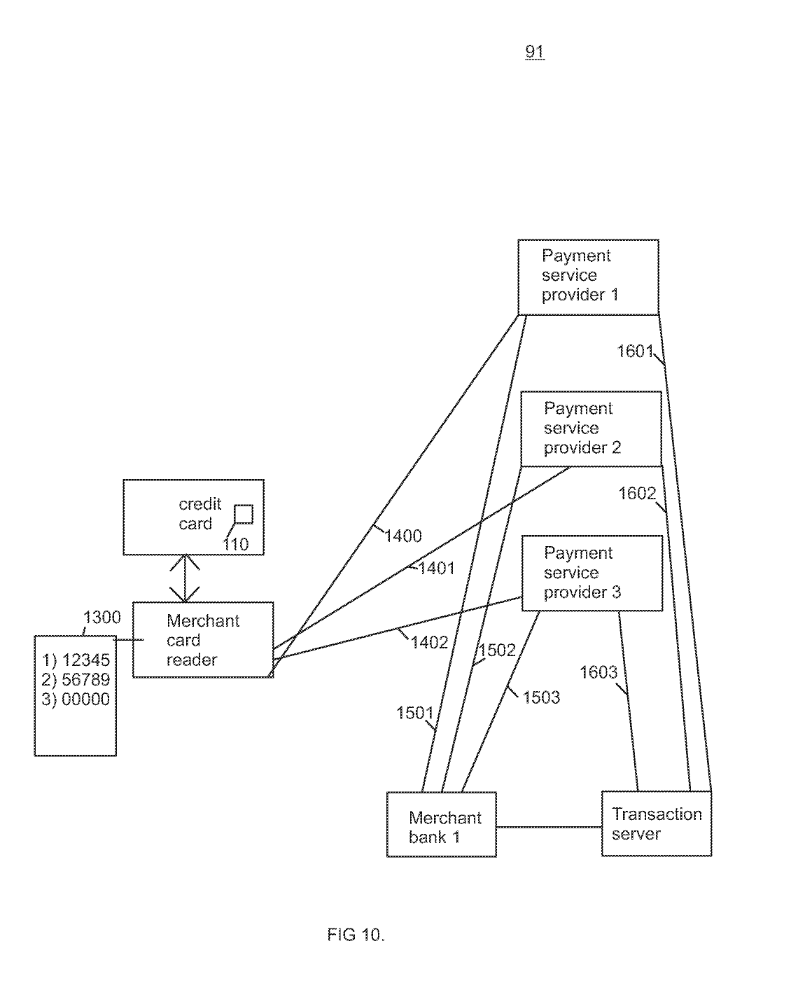

FIG. 10 repeats the overall idea of the invention presented in FIG. 9 otherwise, but in this embodiment payment setup is controlled from the merchant card reader. The merchant card reader chooses the most preferred payment service provider, and chooses the most preferred available payment service provider from the credit card that is inserted into it in accordance with the invention.

Quite clearly instead of the aforementioned preference list, raw data pertaining to the preferentiality, such as data pertaining to price and/or service level in any format can be sent to the payment card and/or the payment card reader for controlling payment setup from the payment card and/or payment card reader. This is applicable to all of the aforementioned embodiments in accordance with the invention.

In FIGS. 9 and/or 10 the transaction server may work in different modes in accordance with the invention: it may only collect and provide payment setup data as explained before. Also alternatively and/or in addition it may use the competitive market waiver approach of embodiments 40 and 50 in accordance with the invention to provide set up of multicurrency payments so that a competitive record of one or more bids is captured of the market when the payment is executed to prove the level or lack of arbitrage in accordance with the invention.

It should be noted that any features, phases or parts of the method 91 can be freely permuted and combined with embodiments 10, 20, 30, 40, 50, 60, 61, 70, 80 and/or 90 in accordance with the invention.

The invention has been explained above with reference to the aforementioned embodiments and several commercial and industrial advantages have been demonstrated. The methods and arrangements of the invention increase competition and transparency in any financial market where the invention is used, and particularly in consumer credit markets. Even more importantly the technical computerised means of coordinating a free market-full risk-low cost position for end users in different currencies provides security and comparability to people and businesses that trade in real goods, because the bypass system of the invention prevents the banks from attaching speculatively high insurance premiums to deals and currency trades that are extremely low risk in practical life. The invention thus significantly reduces the cost of international trade because it liberates the companies to participate in the big free global financial markets instead of being forced to deal with a bank that speculates with the deal of the person or company for the bank's own benefit. For issuing banks the inventive system may be used to reduce the costs these banks need to pay for reciprocal transaction traffic, by making the other banks and/or transaction networks compete for the transaction traffic with more preferential terms.

The embodiments expressed as systems, arrangements and/or devices are also in accordance with the invention when expressed as methods of operation and uses of said systems, arrangements and/or devices, and of course vice versa. A memory unit storing software arranged to implement or realise any of the systems, arrangements and/or methods of the claims and/or aforementioned embodiments is also in accordance with the invention.

The invention has been explained above with reference to the aforementioned embodiments. However, it is clear that the invention is not only restricted to these embodiments, but comprises all possible embodiments within the spirit and scope of the inventive thought and the following patent claims.

### REFERENCES

U.S. Pat. No. 7,357,331 B2, Blossom et al., Selectable multi-purpose card, JPMorganChase Bank N.A.
U.S. Pat. No. 4,700,055 Kashkashkian Jr., Multiple Credit card System.
WO03/010701, Hirka et al., FIRST USA Bank.
“EMV '96 Integrated circuit card specification for payment systems” EMV '96 specifications, 1996.
US 2002/0087455, Tsagarakis et al., Global foreign exchange system 2002.
Joos Cadonau, Chapter 11 OTA and Secure SIM Lifecycle management, Springer, Smart Cards, Tokens, Security and Applications 2008, 257-275, DOI: 10.1007/978-0-387-72198-9_{—}11.

1. A payment card, arranged to clear transactions with at least two accounts, characterised in that, data stored into the memory of the payment card, payment card reader, and/or a network server is arranged to be used in determining an order of preference for the said accounts.

2. A payment card reader, arranged to clear transactions with at least two accounts, characterised in that, data stored into the memory of the payment card, payment card reader and/or a network server is arranged to be used in determining an order of preference for the said accounts.

3. A payment card as claimed in claim 1, characterised in that, the payment card and/or payment card reader is arranged to comprise at least one memory device and/or at least one microprocessor device.

4. A payment card as claimed in claim 1, characterised in that, transactions are arranged to be cleared to the accounts according to the order of preference.

5. A payment card as claimed in claim 1, characterised in that, at least one network server computer is arranged to realise a communication connection to at least one payment card and/or payment card reader.

6. A payment card as claimed in claim 1, characterised in that, the transaction is arranged with the lowest transaction cost to the buyer, seller, card issuer, card reader issuer and/or lowest aggregate transaction cost for any combination of the aforementioned parties.

7. A transaction computer server arrangement, comprises at least one memory storing at least one customer account and at least one communication connection with which at least one customer can access at least one customer account, and at least one communication connection to at least one electronic market where trading is arranged to take place, characterised in that,
at least one user is arranged to accept a fair market price and/or exchange rate,
the transaction server is arranged to conduct and/or start the transaction,
the transaction server is arranged to capture a competitive record of at least one available bid other than the transaction that could have been accepted to complete the said transaction from at least one said electronic market,
said competitive record together with the conducted transaction is arranged to verify the transactional cost of executing the transaction.

8. Transaction computer server arrangement as claimed in claim 7, characterised in that, the transaction server is arranged to automatically choose a transaction with the lowest aggregate transaction cost for the user.

9. Transaction computer server arrangement as claimed in claim 7, characterised in that, the transaction and the competitive record of the bids are stored in the transaction server and/or sent to the user.

10. Transaction computer server arrangement as claimed in claim 7, characterised in that, at least one user can access at least one said account with at least one credit card and/or at least one computer terminal.

11. Transaction computer server arrangement as claimed in claim 7, characterised in that, the transaction server arrangement is arranged to read at least one bank account via an electronic connection and credit at least one received payment to said bank account to at least one customer account in the transaction computer server arrangement.

12. Transaction computer server arrangement as claimed in claim 7, characterised in that, the time difference between the transaction and the capture of the competitive record is arranged short enough that the price volatility remains small compared to the charge for the transaction service.

13. A payment card arranged to access at least one transaction computer server of claim 7.

14. A payment card reader arranged to access at least one transaction computer server of claim 7.

15. A payment card comprising memory, characterised in that,
the payment card is arranged to receive a data update from a network server,
the payment card is arranged to store said data into memory,
the said data update is arranged to be used in controlling financial transaction setup between the user of the card and merchants accepting the card.

16. A payment card reader comprising memory, characterised in that,
the payment card reader is arranged to receive a data update from a network server,
the payment card reader is arranged to store said data into memory,
the said data update is arranged to be used in controlling financial transaction setup between a user of a payment card and the merchant accepting the card.

17. A payment card, comprising a memory chip 110, characterised in that, the memory chip 110 is arranged to be inserted into a card reader in a mobile phone.

18. A payment card, arranged to clear transactions with at least one account, the said payment card comprising data for accessing at least two electronic deal clearing service providers, characterised in that,
transactions from at least two deal clearing service providers are arranged to be consolidated into one account, and/or
the said payment card is arranged to comprise data indicating the order of preference of the said at least two deal clearing service providers.

19. A payment card reader, arranged to clear transactions with at least one account, the said payment card reader comprising data for accessing at least two deal clearing service providers, characterised in that,
transactions from at least two deal clearing service providers are arranged to be consolidated into one account, and/or
the payment card reader is arranged to store the order of preference of said at least two deal clearing service providers and is arranged to clear a transaction via the most preferred available deal clearing service provider.

20. A method for payment set-up in a electronic payment system comprising a plurality of payment cards (100), at least one payment service provider means, at least one transaction server for storing service information received from at least one payment service provider means, and a electronic communication network via which payments are established in the system, characterised in that,
at least one transaction server is in connection with at least one payment service provider means and stores the service information received via the connection,
all or part of the service information stored in the transaction server is transmitted to a control means (110) in the payment card (100), and
the control means (110) in the payment card (100) stores the service information received from the transaction server, and the service information stored in the control means (110) is used in controlling payment set-up from the payment card (100).

21. A method for payment set-up in a electronic payment system comprising a plurality of payment card readers (200), at least one payment service provider means, at least one transaction server for storing service information received from at least one payment service provider means, and a electronic communication network via which payments are established in the system, characterised in that,
the transaction server is in connection with the payment service provider means and stores the service information received via the connection,
all or part of the service information stored in the transaction server is transmitted to the payment card reader (200), and
the payment card reader (200) stores the service information received from the transaction server, and the service information stored in the card reader (200) is used in controlling payment set-up from the payment card reader (200).

22. A electronic payment system comprising a plurality of payment cards (100), at least one payment service provider means, at least one transaction server, and a electronic payment network via which payments are arranged to be established in the system, characterised in that, the electronic payment system comprises at least one transaction server, the transaction server being arranged to be in connection with at least one payment service provider means, a control means (110) in the payment card is (100) arranged to be in connection with the transaction server for the transmission of service information, the control means (110) being arranged to control the payment set-up of the payment card (100) on the basis of the service information.

23. A electronic payment system comprising a plurality of payment card readers (200), at least one payment service provider means, at least one transaction server, and a electronic payment network via which payments are arranged to be established in the system, characterised in that, the electronic payment system comprises at least one transaction server, the transaction server being arranged to be in connection with at least one payment service provider means, at least one payment card reader (200) is arranged to be in connection with the transaction server for the transmission of service information, the payment card reader (200) being arranged to control the payment set-up of the payment card reader (200) on the basis of the service information.

24. An electronic payment method, used in a system comprising at least one memory storing at least one customer account and at least one communication connection with which at least one user can access at least one said customer account, and at least one communication connection from said memory to at least one electronic market where trading is arranged to take place, characterised in that,
the transaction is conducted and/or started,
a competitive record of at least one available bid other than the transaction that could have been accepted to complete the said transaction from at least one said electronic market is captured and stored,
said competitive record together with the conducted transaction verifies the cost of executing the transaction.

25. An electronic payment method as claimed in claim 24, characterised in that, automatically a transaction with the lowest aggregate transaction cost for the user is chosen.

26. An electronic payment method as claimed in claim 24, characterised in that, the transaction and the competitive record of the bids are stored in the transaction server and/or sent to the user.

27. An electronic payment method as claimed in claim 24, characterised in that, at least one user can access at least one said account with at least one credit card and/or at least one computer terminal.

28. An electronic payment method as claimed in claim 24, characterised in that, at least one bank account is read via an electronic connection and at least one received payment to said bank account is credited to at least one said customer account.

29. An electronic payment method as claimed in claim 24, characterised in that, the time difference between the conducted transaction and the capture of the competitive record is short enough that the price volatility remains small compared to the transaction cost.

30. The payment card reader as claimed in claim 2, characterised in that, the payment card and/or payment card reader is arranged to comprise at least one memory device and/or at least one microprocessor device.

31. The payment card reader as claimed in claim 2, characterised in that, transactions are arranged to be cleared to the accounts according to the order of preference.

32. The payment card reader as claimed in claim 2, characterised in that, at least one network server computer is arranged to realise a communication connection to at least one payment card and/or payment card reader.

33. The payment card reader as claimed in claim 2, characterised in that, the transaction is arranged with the lowest transaction cost to the buyer, seller, card issuer, card reader issuer and/or lowest aggregate transaction cost for any combination of the aforementioned parties.
